(19) United States
(12) Patent Application Publication
(10) Pub. No.: US 2019/0311019 A1
(43) Pub. Date: Oct. 10, 2019

(54) One Click Universal Probability Calculator

(71) Applicant: Douglas Moura Miranda, Belo Horizonte (BR)

(72) Inventor: Douglas Moura Miranda, Belo Horizonte (BR)

(73) Assignee: Douglas Moura Miranda, Belo Horizonte (BR)

(21) Appl. No.: 15/949,167

(22) Filed: Apr. 10, 2018

(51) Int. Cl. G06F 17/18; G06F 9/451; G06F 7/544; G06F 17/30

(52) U.S. Cl. CPC G06F 17/18; G06F 17/30991; G06F 7/544; G06F 9/451

(57) ABSTRACT

An apparatus and a method to assist people who is not an expert in statistics to calculate probabilities when in possession of a set of data. The purpose of the “One Click Universal Probability Calculator” is to be a practical and simple tool to calculate probabilities given a data set with continuous or discrete values not requiring statistical knowledge from the user. The tool is one-click based, requiring minimum actions from the user. It also provides an estimate for the uncertainty of the calculated probability in an intuitive way for the user. All the related statistical concepts are treated in the background by our new method. The tool can be presented to the user in different ways: website/software, executable file, code library file (.dll) for integration with other software, and finally, embedded into an electronic pocket calculator.

### CROSS-REFERENCE TO RELATED APPLICATIONS

This invention has been granted a license under 35 U.S.C. 184 with number U.S. 62/587,501. Foreign Filing License Granted: Dec. 15, 2017. Now we file a nonprovisional application for patent as described in this document.

### 1) BACKGROUND AND BRIEF SUMMARY OF THE INVENTION

In terms of technical field of invention, the present invention relates to statistics and probability, in particular, to a method and apparatus for assisting users who are not experts in statistics to be able to calculate probabilities in a practical and intuitive way.

The real-life environment is made of probabilistic data by nature and the ability to make decisions based on probabilities is important not only in business but also in the everyday life. It is common having a decision maker in possession of a set of data willing to assess risks by calculating the probability of obtaining a number greater or less than a specific value. An example of a common situation is given by a worker commuting to office every day. He has a data set comprised of actual travel times from home to office and he wishes to know the probability of having a travel time shorter than a desired amount of time. But considering he does not have a statistical tool or even statistical knowledge to use such tool, how could he perform such calculation? Situations like that are faced by people frequently, and because there isn't a simple and immediate way to answer these question (from the perspective of a person with no statistical knowledge), and considering the person usually needs an answer, he is forced to estimate a number based in his intuition or based in averages, without considering properly the variation of the phenomenon he is trying to make an inference about.

In terms of the state of the prior art, available solutions in the market are able to compute probabilities for a given data sample but they demand a significant knowledge of statistics. Many people, including administrators from small companies and salespeople from stores, deal with decisions involving variation, which implies in probability calculations, and they do not have a tool that allows them to perform such calculation without having to worry about statistical concepts and assumptions. The invention offers a solution for this problem.

The invention is a practical tool to calculate probabilities given a data set comprised of continuous or discrete values without requiring statistical knowledge from the user such as: normality assumptions, goodness test, transformations, type of the probability distribution (gamma, log-normal, exponential distribution, binomial, others), frequency tables and others concepts. If the user has a data set and he wishes to calculate the probability of taking a number less than a specified value (cut-off point), he just needs to click on a single button in the interface of the product. It also provides an estimate for the uncertainty of the calculated probability in an intuitive way for the user. All the related statistical concepts are treated in the background by our new method.

Ultimately the product aims to make probability calculations more inclusive, allowing people with no statistical knowledge and people who are not experts in statistics to make those calculations in their everyday life or business.

Section 2 provides a brief description of the drawings, Section 3 gives detailed information about the product and the method. Our claims are based on two things. One is the product itself including its variants, which is described in Section 3.1 with focus on how the user interacts with the product. And the other point is the method (how the probabilities are computed), which is described in Section 3.2 with focus on the specific procedures used to compute the probabilities.

Once the product is in the market, we′d like to protect our unique interface based on one click calculation and also protect the method used to perform such calculations. Our claims are described in Section 4.

### 2) BRIEF DESCRIPTION OF THE DRAWINGS

The figures listed below are explained in more details at Section 3.

FIG. 1: machine test, illustrating the input, transformation and output of the tool.

FIG. 2: variant 1 of the tool (executable file).

FIG. 3: input entry for variant 2 of the tool (software or website).

FIG. 4: output for variant 2 of the tool (software or website).

FIG. 5: variant 3 of the tool (embedded into a calculator).

FIG. 6: example of a Cumulative Probability Function (Section 3.2.1.2) built from a Cumulative frequency table of the developed method.

FIG. 7: illustrative case for everyday life—input file—Section 3.2.4.

FIG. 8: illustrative case for everyday life—output file—Section 3.2.4.

FIG. 9: interface of the website version (prototype)

FIG. 10: step 1 for data input in the prototype interface of the invention

FIG. 11: step 2 for data input in the prototype interface of the invention

FIG. 12: output using the prototype of the invention

FIG. 13: results for Anderson-Darling test (a) and for Kolmogorov-Smirnov test (b) when solving the problem using the software Minitab, in order to compare with the invention.

FIG. 14: Goodness of Fit Test using software Minitab for the data sample of Table 8, when solving the problem using the software Minitab, in order to compare with the invention.

FIG. 15: Maximum likelihood Estimates of Distribution Parameters, when solving the problem using the software Minitab, in order to compare with the invention.

FIG. 16: cumulative Distribution Function, when solving the problem using the software Minitab, in order to compare with the invention.

### 3) DETAILED DESCRIPTION OF THE INVENTION

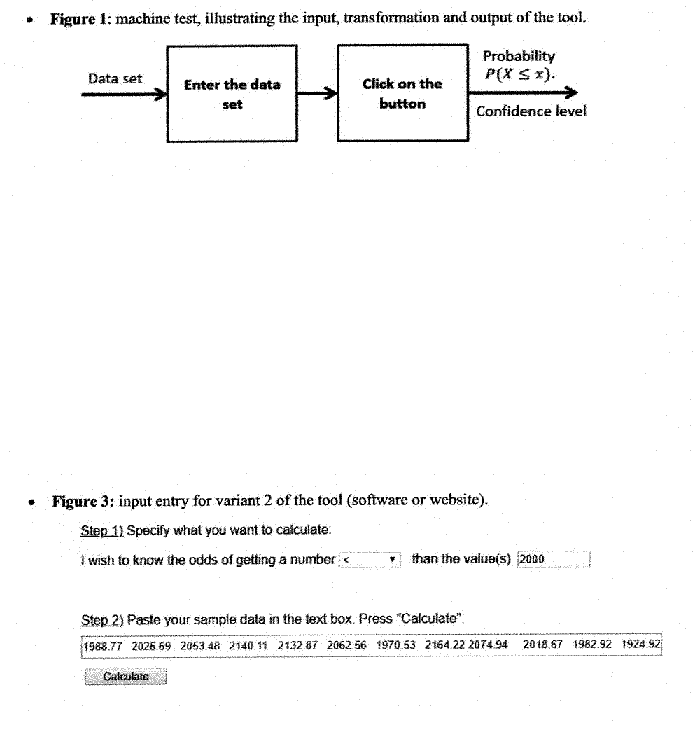

The “One Click Universal Probability Calculator” is a product able to process a data set of values given by the user and able to return the probability of taking a value less/greater than the specified cut-off point. The process is seen in FIG. 1.

The product can be seen as a machine that will process the data set using a well-defined and replicable method and then return the answer to the user. By answer we mean the probability P(X≤x) that represents the odds of getting a number smaller or equal to a cut-off point x. It also includes the probability of getting a number between two cut-off points, P(x₁≤X≤x₂), and math symbols: <, ≤, >, ≥. The other output is the confidence level which in this context means an estimate of how far the calculated probability might be from the true answer. The data set comprises the sample data, the value(s) of the cut-off point(s) and the math symbol.

All the statistical knowledge necessary to perform the calculation is embedded in the product, and applied while processing the data set, not requiring such knowledge from the user. The key is having a simple interface and an intelligent method to process the input using proper statistical concepts. There are three features that differentiates the product from others:
1. The product is designed to require a minimum number of actions from the user. As showed in FIG. 1, once the data is entered, it is only necessary to press a button.
2. The product is designed to not require statistical knowledge from the user. Other tools on the market require from the user one or more of the following actions to return the same probability calculations, while our product does not require any of them:
   Normality test.
   Test of goodness to identify which probability function better fits the data set.
   Use of transformation methods such as Johnson's family of distribution.
   Knowledge of the type or shape of the distribution function (gamma, log-normal, exponential distributions and others) and if the data is continuous or discrete.
   Interaction with a “virtual assistant”. It happens when the user needs to answer questions from an “assistant” of the tool in order to be guided through the process.
3. The product output gives an information of how far the calculated probability might be from the true probability value.

3.1) Modes of Utilization of the Product (Versions)

The “One Click Universal Probability Calculator” is a tangible product that can be available in the market in some different forms/versions such as: an executable file, a website or imbedded into a scientific calculator. Details are provided in the next sections.

### 3.1.1) Mode 1: Executable File

The product can be commercialized as an “executable file” without interface with the user (no windows) where the input is a text file (or equivalent) and the output is another text file (or equivalent) with the results of the calculation. This mode aims to give to the client two different ways of utilization.

In one way, the user can just click on the executable file, and after that, an output file is generated with the result. In another way, it allows interaction of the product with other tools/software where a client software or program can call the executable file of the product by using something equivalent to function “system(command)” in C++ and others computer languages; and after that it is possible for the program to import the result of the calculation from the output file.

FIG. 2 illustrates the utilization, where we see the executable file (.exe), input and output text files. The cut-off value for which is desired to calculate the probability is entered in the first line of the input file, in this example we wish to compute the probability of having a value smaller than 90. After that, in the next lines, it is entered the sample values such as 113.47, 86.62 and so on. As showed in the output file (FIG. 2, right side), the result is 71.25%.

Because the probability calculation is strongly influenced by the size of the sample, we also provide the estimated range for the actual probability in the output file. Naturally, the higher the sample size, the more accurate is the answer, and it is fair to give the user an estimation of that accuracy. This information is also extended to the other forms of utilization.

Deriving from this form of utilization, in terms of integration with other software, instead of having .exe file, the computer programming with the implementation of our method can be compiled as a code library file (.dll).

### 3.1.2) Mode 2: Software or Website

Another version of the product consists of a software, opened through an executable file (.exe) or a website with an interface that allows the user to perform the actions listed in FIG. 1. Optionally, the product can display supplementary information such as a graph of the histogram and cumulative probability function.

In terms of market, the form as a software that can be opened through an executable file can be seen as a product where the customer can buy or download the files and run it from his computer. The form as a website can be seen as a service, where the operations are performed from a server also allowing access management.

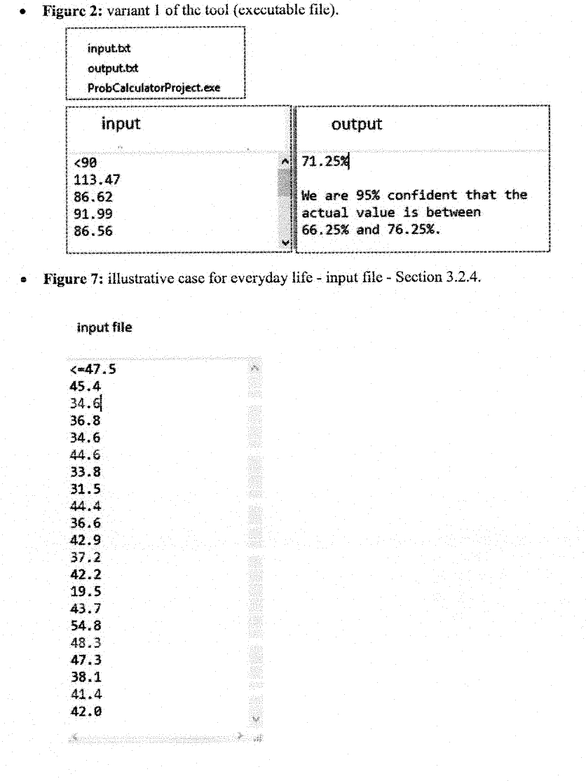

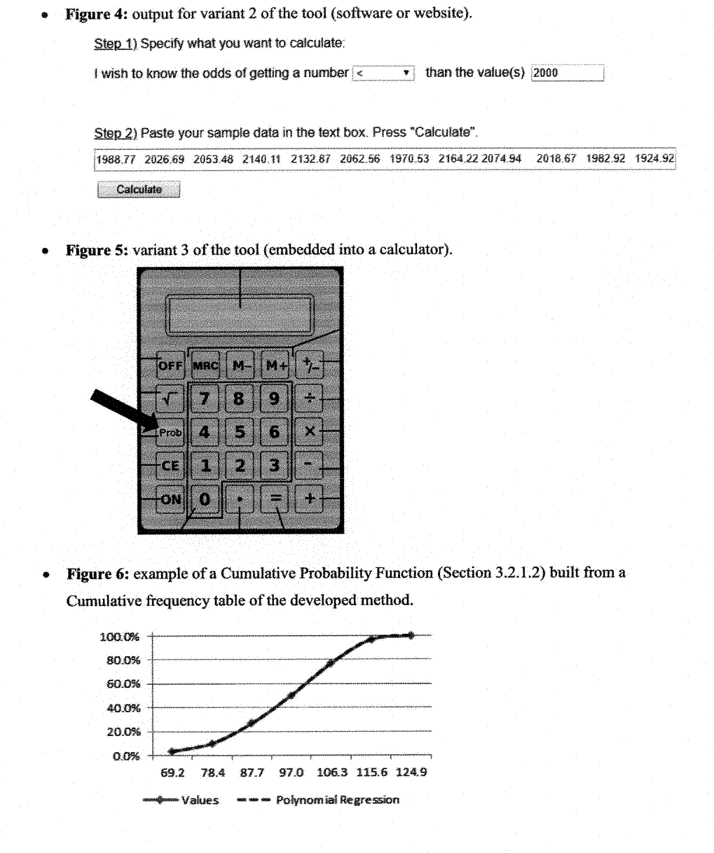

FIG. 3 illustrates the interface of this mode of utilization. Aligned with FIG. 1, the user enters the data of the sample, populates the value of x to have probability P (X≤x) and then press the button “Calculate”. The result is returned as showed in FIG. 4.

3.1.3) Mode 3: Embedded into a Calculator

Another form of the product is given by embedding it into an electronic pocket calculator or scientific calculator, where the user performs the actions of FIG. 1 by typing the data using the calculator pad and then pressing a key.

FIG. 5 shows the utilization in a calculator where the probability calculation is one more mathematical operation performed by the calculator. The user can press “Prob” to start the data entrance and after that press key “=” to get the answer in the display.

### 3.2) The Developed Method to Compute the Probabilities

The developed methods consist of two approaches: one based on empirical distributions and other based on theoretical distributions. The outputs of these approaches can be combined based on studied criteria in order to return the final probability value to the user.

### 3.2.1) Approach Using Empirical Distributions

The method builds a cumulative frequency table using it to determine piecewise functions that estimate the cumulative function and then calculating the probability P (X≤x). The frequency table is strongly influenced by the number of bins used to build it. Because it is not possible to know the ideal number of bins, we build frequency tables with different number of bins, then we evaluate the quality of the frequency tables and combine the probability calculations from the best evaluated tables in order to have a final output.

The terminology is given as follows: S is a set with the sample values x₁ to xₙ, b^{r} is a reference number of bins, Q is the quantity of bins to be evaluated. The functions min(S), max(S), mean(S), dev(S) computes the minimum, maximum, mean and standard deviation of a given set S. We also have the data set D with the values of the sample data, cut-off point and data structures used by the algorithm. This method is summarized in Algorithm 1.

Algorithm 1: main loop for the empirical approach

| | |
|---|---|
| 1 | k₀ = min(S) |
| 2 | kf = max(S) |
| 3 | bf = b^{r} * p1; |
| 4 | b0 = b^{r} * p2; |
| 5 | deltaBin = (bf − b0) / Q; |
| 6 | for (q = 1 to Q) do |
| 7 | b = round(bf − q * deltaBin); |
| 8 | w = (kf − k₀) / b; |
| 9 | [T1,T2] = Tables(D,b,w); |
| 10 | tPenal(q) = TableScore(D,T1,T2); |
| 11 | m(q) = ComputePDF(D); |
| 12 | end |
| 13 | ComputeFinalPDF(D,tPenal,m); |

In Algorithm 1, lines 1 to 4 initializes variables used within the loop, where p1 and p2 are parameters of the algorithm determined experimentally. Line 7 computes the number of bins and line 8 the width of the bin, both used in line 9 to build the relative frequency table (T1) and the cumulative frequency table (T2). In line 10, the function TableScore evaluates the quality of the relative frequency table returning a penalty score. In line 11, function ComputePDF calculates the required probability by determining piecewise functions from the cumulative frequency table and then estimating the cumulative function to compute the probabilities. The final result is returned by function ComputeFinalPDF in line 13, combining the results from each iteration of the main loop.

### 3.2.1.1) Relative Frequency Table

In Algorithm 1, line 9, we build the relative frequency table (T1) and differently from the traditional ones that are based on discrete numbers while counting the frequency of occurrences in each interval, our table relies on continuous numbers.

Initially we build the intervals as follows: let LBᵢ and UBᵢ be the lower bound and upper bound for the interval i, respectively. We have LBᵢ=UBᵢ₋₁ if i>1 and LBᵢ=min(S)−w/2 if i=1, where k₀, k_{f} and w are already described in Algorithm 1. We also have UBᵢ=LBᵢ+w. The frequency for interval i using the traditional approach (Fᵢ^{t}) is given by counting the number of occurrences in the sample within the bounds of the respective interval, meaning that Fᵢ^{t} is always a discrete number.

In our method, the frequency Fᵢ is calculated by allowing to split an occurrence between two adjacent intervals which results in a continuous number. We do that as follows: let mᵢ=(LBᵢ+UBᵢ)/2 be the middle point of the interval i,

$$f 1 = \frac{0.5 ( x - u )}{m - u} + 0.5$$

and f2=1−f1, where u=UBᵢ, j=i+1, if x>mᵢ and x<UBᵢ, or u=UBᵢ, j=i−1, if x≤mᵢ and x≥UBᵢ. By doing that, the relative frequency Fᵢ=Fᵢ+f1 and Fⱼ=Fⱼ+f2, where Fᵢ is initialized with zero for all intervals i before the procedure. Therefore, a given x from the sample S is counted in the interval i as a whole only if x=mᵢ, otherwise the occurrence is proportionally split between the interval i and the closest interval to x.

An interesting consequence of such method is the fact that the number of intervals with zero occurrences or equal occurrences is reduced, which might be beneficial specially for small samples. Another point is that the method does not change the total number of occurrences.

We give a numerical example to illustrate the method using the data set from Table 1.

TABLE 1
Data set with 30 samples

| | | |
|---|---|---|
| 86.96 | 120.23 | 96.27 |
| 112.19 | 94.99 | 104.36 |
| 114.18 | 111.08 | 100.92 |
| 105.60 | 115.18 | 113.41 |
| 70.65 | 102.68 | 87.39 |
| 86.17 | 94.55 | 97.63 |
| 82.64 | 89.15 | 104.84 |
| 89.75 | 76.74 | 92.48 |
| 84.36 | 94.53 | 105.61 |
| 108.52 | 103.19 | 64.51 |

Assuming 7 intervals, the frequency table is seen in Table 2 where we see the bounds for each interval as well as the frequency using the traditional method (Fᵢ^{t}) and our method (Fᵢ).

TABLE 2
example of frequency table

| i | LBᵢ | UBᵢ | Fᵢ^{t} | Fᵢ |
|---|---|---|---|---|
| 1 | 59.87 | 69.15 | 1 | 1.34 |
| 2 | 69.15 | 78.44 | 2 | 1.39 |
| 3 | 78.44 | 87.73 | 5 | 4.55 |
| 4 | 87.73 | 97.01 | 7 | 7.05 |
| 5 | 97.01 | 106.30 | 8 | 7.17 |
| 6 | 106.30 | 115.59 | 6 | 6.28 |
| 7 | 115.59 | 124.87 | 1 | 2.22 |

### 3.2.1.2) Cumulative Frequency Table

Tables T1 and T2 are created in line 9 and they are formed by b points (#bins) with values, xᵢ, i=1 . . . b. For line 11, Algorithm 1, we determine the piecewise function ƒ(x) that estimates the cumulative probability function. The function ƒ(x) is formed by two functions as described in equation (1).

$$f ( x ) = \{ \begin{matrix}{f}_{1} ( x ) if x \leq {LB}_{i} \\ {f}_{2} ( x ) if x > {LB}_{i - 1}\end{matrix} \qquad ( 1 )$$

where ƒ₁(x) estimates the left side of the cumulative function and ƒ₂ (x) the right side. Note there is an overlap in the interval LBᵢ₋₁≤x≤LBᵢ. The truncation point LBᵢ=xᵢ is given by the lower bound of the

$$bin i = ⌈ \frac{b}{2} ⌉ + 1.$$

In equation (1), ƒ₁(x) and ƒ₂(x) are third-degree polynomial regressions of the points xᵢ from the cumulative frequency table (T2). The use of a piecewise function has showed to be superior when compared with a single function while estimating the cumulative function in preliminary experiments.

Once ƒ(x) is determined, the probability P(X≤x) can be calculated at any value x using equation (2).

$$f ( x ) = \{ \begin{matrix}{f}_{1} ( x ) = {a}_{1} * {x}^{3} + {a}_{2} * {x}^{2} + {a}_{3} * x + {a}_{4} if x < {LB}_{i - 1} \\ {f}_{2} ( x ) = {b}_{1} * {x}^{3} + {b}_{2} * {x}^{2} + {b}_{3} * x + {b}_{4} if x > {LB}_{i} \\ {f}_{3} ( x ) = ( 1 - p ) * {f}_{1} ( x ) + p * {f}_{2} ( x ) if {LB}_{i - 1} \leq x \leq {LB}_{i}\end{matrix} \qquad ( 2 )$$

where p=(x−LBᵢ₋₁)/(LBᵢ−LBᵢ₋₁). The equation ƒ₃(x) is a combination of ƒ₁(x) and ƒ₂(x) and it works in the region of the truncation point: LBᵢ≤x≤LBᵢ₊₁

Building on the data set from Table 1, the cumulative frequency table is seen in Table 3 where CF is the cumulative frequency, CF % is the cumulative frequency expressed in percentage and CF %′ is the cumulative frequency estimated by the polynomial regressions (set of equations 2).

TABLE 3
example of frequency table

| i | LBᵢ | UBᵢ | Fᵢ | CFᵢ | CF %ᵢ | CF %ᵢ′ |
|---|---|---|---|---|---|---|
| 1 | 59.87 | 69.15 | 1.34 | 1.34 | 4.46% | 4.46% |
| 2 | 69.15 | 78.44 | 1.39 | 2.73 | 9.10% | 9.11% |
| 3 | 78.44 | 87.73 | 4.55 | 7.28 | 24.26% | 24.26% |
| 4 | 87.73 | 97.01 | 7.05 | 14.33 | 47.77% | 47.76% |
| 5 | 97.01 | 106.30 | 7.17 | 21.50 | 71.67% | 71.67% |
| 6 | 106.30 | 115.59 | 6.28 | 27.78 | 92.60% | 92.61% |
| 7 | 115.59 | 124.87 | 2.22 | 30.00 | 100.00% | 100.00% |

Applying equation (2) with truncation points i=4 and i 1=5, we have:

ƒ1(x)=0.000x³+0.002x²−0.206x+5.983 if x<97.0 (3a)

ƒ2(x)=0.000x³+0.006x²−0.596x+18.534 if x>106.3 (3b)

ƒ3(x)=(1−p)ƒ₁(x)+pƒ₂(x) if 97.0≤x≤106.3 (3c)

FIG. 6 plots the values of the cumulative frequency from Table 3 and also the estimated curve using the equations (3a), (3b) and (3c).

Using FIG. 6, it is easy to estimate any probability, for example, it is possible to see that the probability of taking a value less than 106 is approximately 80%. A better estimation is obtained using the set of equations 3. Let's assume it is desired to calculate the probability P(X≤100). The value 100 is within the interval 97.0≤x≤106.3, so it will be used the equation (3c), where the parameter p is given by: p=(100−97.0)/(106.3−97.0)=0.32. The equations (3a) and (3b) are respectively: ƒ1(100)=58.4% and ƒ2(100)=58.7%. Finally, the equation (3c) results: ƒ3(105)=(1−0.32)*58.4%+0.32*58.7%=58.5%.

Still in Algorithm 1, the function TableScore in line 10, evaluates the quality of the relative frequency table returning a penalty score tPenal(q) for each bin size in the main loop. This is done by measuring the presence of three features:
1. Presence of consecutive bins with relative frequency equal to zero. The higher the presence, the worse, i.e. the higher the penalty.
2. The maximum difference between two consecutive cumulative probabilities (CF. Est. (%)ᵢ−CF. Est. (%)ᵢ). The higher, the worse.
3. For bins to the left of the median of the sample, count the occurrences of situations where Rel.Freqᵢ>Rel.Freqᵢ₊₁. Analogue, for bins to the right of the median of the sample, the occurrence of situations where Rel.Freqᵢ<Rel.Freqᵢ₊₁. The more occurrences, the worse.

Finally, the final result is returned by the function ComputeFinalPDF in line 13, combining the results from each iteration of the main loop. The vector m(q) stores the calculated probability P (X≤x) and tPenal(q) stores the penalties while evaluating the quality the frequency and relative tables, for each bin size q in the main loop. The final result is given by the weighted probability: Σ_{q=1}^{q=Q}m(q)*tPenal(q), where Σ_{q=1}^{q=Q}tPenal(q)=1 and 0≤tPenal(q)≤1 for q=1, . . . , Q.

### 3.2.2) Approach Using Theoretical Distributions

The method builds a cumulative frequency table to have an empirical cumulative distribution function, and then compare it with a set of theoretical distributions to pick the one with the best approximation. Because the frequency table is strongly influenced by the number of bins used to build it, we devise different frequency tables with different number of bins. Note that one difference here is the fact that most of the methods in the related literature use tests of goodness such as Kolmogorov-Smirnov and Chi-squared, where the comparison is made using the empirical distribution that comes directly from the sample, not from cumulative frequency tables.

This strategy is summarized in steps described in Algorithm 2. The terminology is the same previously used in Algorithm 1.

Algorithm 2: main loop for approach using theoretical
probability functions

| | |
|---|---|
| 1 | k₀ = (min(S) − mean(S)) / dev(S); |
| 2 | kf = (max(S) − mean(S)) / dev(S); |
| 3 | bf = b^{r} * p1; |
| 4 | b0 = b^{r} * p2; |
| 5 | deltaBin = (bf − b0) / Q; |
| 6 | for (q = 1 to Q) do |
| 7 | b = round(bf − q * deltaBin); |
| 8 | w = (kf − k₀) / b; |
| 9 | [T1, T2] = Tables(D,b,w); |
| 10 | getBestFit(D,T1,T2,tScore); |
| 11 | end |
| 12 | selectFunction(tScore,c); |
| 13 | ComputePDF(D); |

Algorithm 2 is similar to Algorithm 1 considering that the framework of the strategy is to explore different cumulative frequency tables that comes from a different number of bins. The difference here is in line 10, where for a given cumulative table we execute the function “getBestFit” that compares the probability from the current table with a set of theoretical distributions.

The function “getBestFit” works as follows: for each theoretical distribution function d, for each value xᵢ from the cumulative frequency table, we calculate the mean error E_{d}=[Σᵢ₌₁^{i=Q}abs(F^{E}(xᵢ)−F^{T} (xᵢ))]/Q, where Q is the number of bins, F^{E} is the empirical cumulative probability function and F^{T} is the theoretical cumulative function. The error E_{d} is computed for each one of the following distributions: Normal, Log-Normal, Gamma, Exponential and Student. After that we update tScore_{d}, where tScore_{d}=tScore_{d}+1 for the two smallest E_{d}.

In line 12 of Algorithm 2, we select one theoretical probability function using tScore_{d} and a criterion c (parameter). If c=1, we select function with the best score tScore_{d}, if c=2 we add a penalty in E_{d}, by doing E_{d}=E_{d}+pen*D, where pen is a parameter and D is the Kolmogorov-Smirnov test statistic: D=max(abs(G(xᵢ)−F^{T} (xᵢ)), where G(xᵢ) is the empirical cumulative distribution function Finally, in line 13, once we have selected the distribution function we can compute the desired probability P (X≤x).

### 3.2.3) Combined Approach

In our method we devise an approach combining the approach using empirical distributions (Section 3.2.1) with the approach using theoretical distributions (Section 3.2.2). We start with Algorithm 2, and in line 10, function “getBestFit”, while computing the error E_{d}, we also compute OE_{d} that is de overall error for each distribution function d, along all sizes of bin in the main loop. If min(OE_{d})>trigger, then we switch to Algorithm 1, using the empirical method, where trigger is a parameter. Otherwise, we return the output given by Algorithm 2.

When computing P(X≤x), if x<min(S) or x>max(S), it is used the theoretical approach (Algorithm 2), where S is the sample given by the user. All the parameters of the method were determined by massive computational experiments using an optimization algorithm developed by ourselves (not part of this invention).

### 3.2.4) Computational Experiments and Results

Here we summarize the results for experiments performed with the developed method aiming to demonstrate the quality of our method (part of the invention) by comparing it with other methods from the related literature, listed as follows:
1. Empirical cumulative probability function: it is the simplest approach where

$$P ( X \leq x ) \sim ( \frac{q}{Q} ) ,$$

where q is me number of occurrences smaller or equal to x and Q is the sample size.
2. Johnson system of distributions.
3. Burr type XII distribution.

We choose Johnson and Burr distributions as benchmarks because they are very popular among professionals, researchers and products in the field. In order to test the developed method, we devise 9 instances with populations of 100000 values with the following features:
Population 1: Normal distribution, with μ=100.12 and σ=19.74
Population 2: Lognormal distribution, with μ=100.12 and σ=20.12
Population 3: Lognormal distribution, with μ=100.12 and σ=39.89
Population 4: Gamma distribution, with μ=100.02 and σ=100.05
Population 5: Exponential distribution, with μ=100.30 and σ=20.06
Population 6: Weibull distribution, with μ=100.10 and σ=20.06
Population 7: Weibull distribution, with μ=100.53 and σ=49.46
Population 8: Logistics distribution, with μ=99.78 and σ=20.32
Population 9: Logistics distribution, with μ=100.01 and σ=58.84

Considering the accuracy of the calculation of the probability P(X≤x) is also related to the distance from x to the mean, each population is evaluated in 13 cut-off points: from the point μ−3σ to the point μ+3σ with increment of 0.5σ. It is also used 3 different sample sizes (n): 20, 30, 50. For each method, it is performed 17550 probability calculations: 9 instances, 3 sample sizes, 50 replications (different samples), 13 cut-off points (values for x). The accuracy of the methods in the experiments is measured by the mean absolute percentage error (MAPE) and it expresses accuracy as a percentage of the error.

Table 3 presents the results, reporting the overall mean of the error and the 95th percentile. We see that the developed method shows error significant smaller than the other both for the overall mean and for the 95^{th} percentile.

TABLE 3
results

| Method | Mean | 95th |
|---|---|---|
| This invention | 2.38% | 8.98% |
| Empirical | 5.77% | 10.97% |
| Johnson | 3.01% | 10.75% |
| Burr | 3.03% | 10.73% |

### 3.2.5) Confidence Level of the Calculated Probability

When calculating the probability P (X≤x), we also compute an empirical confidence level to give the user an estimation of the accuracy of the answer (how far the calculated probability might be from the true probability). In order to estimate this accuracy, we devised an experiment similar to the one described in Section 3.2.4. The computational experiment was designed using the same 9 instances, but with more replicas (200) and more values for the distance from the mean and for the sample size in order to map a broader space of combinations. For the distance from mean, we used cut-off points in the interval [−5, . . . , +5] with increment equal to 0.2 standard deviation units; and for the sample size we used values in the interval [3, . . . , 200, . . . 1000] with increment equal to 1 unit from 3 to 200 and equal to 50 units from 200 to 1000. For each combination of cut-off point and sample size, we executed 200 probability calculations (replications), measured the errors and counted the number of calculations within a given error interval among the 9 instances.

For example, to know the confidence level of having an error up to 5 percentage points, for a given distance from the mean and sample size, we counted the number of occurrences where the absolute error was smaller than 5 and divided it by 1800 (total number of calculations obtained from 9 instances and 200 replicas).

For inputs from the user where the cut-off point and sample size are different than the tested combinations, we use an interpolation from the results of the experiment.

An example of the utilization of this confidence level is seen in FIG. 2 as part of the output file, where we return the probability P(X≤90)=71.25%, where we are 95% confident that the actual value is between 66.25% and 76.25%. By doing that we give the user an estimation of the quality/accuracy of the probability returned by the product.

3.2.6) Case with Discrete Variables

If the data entered by the user is discrete, we devise a method similar to the ones described in the previous sections, with some adjustments. We have a set of discrete theoretical distributions: Binomial, Geometric, Negative Binomial and Poisson. As described in Section 3.2.3 (combined approach), if the best approximation by a theoretical distribution returns an error greater a trigger (parameter) we use an empirical distribution as described in Algorithm 1 with few adjustments do deal with the integer nature of a discrete variable.

### 3.2.7) Illustrative Case for Everyday Life

In order to illustrate the usefulness of the product, we show an example involving the travel time of a given worker from home to office, mentioned in Section 1 while describing the background of the invention. We assume the worker has a data set comprised of 20 values of actual travel times from home to office (Table 4) and he wishes to know the odds of having a travel time shorter than 47.5 minutes.

TABLE 4
Data set with 20 samples

| | | | |
|---|---|---|---|
| 45.4 | 33.8 | 37.2 | 48.3 |
| 34.6 | 31.5 | 42.2 | 47.3 |
| 36.8 | 44.4 | 19.5 | 38.1 |
| 34.6 | 36.6 | 43.7 | 41.4 |
| 44.6 | 42.9 | 54.8 | 42.0 |

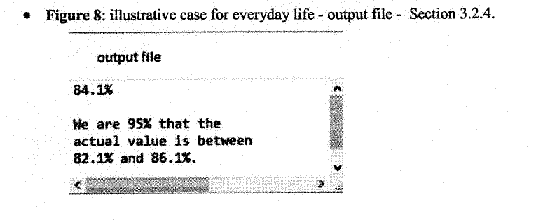

Considering the mode of utilization 1 (Section 3.1.1), the user just needs to provide the sample from Table 4 in the text format as seen in FIG. 7. After that, the user just has to click on the executable file and the output file is generated with the result (FIG. 8). In this example, the tool returns P(X≤47.5)˜84.1% with 95% confidence that the actual probability is between 82.1% and 86.1%. We believe this is a useful information, easy to understand, that not only returns the wished probability but also gives an information of the accuracy of the answer. In order to have that answer the user just provided the sample he had collected and clicked on the file to execute it, with no need of statistical knowledge.

### 3.2.8) Illustrative Case in Manufacturing

Here we illustrate the usefulness of the product with real field data from the electronic industry. Data from a manufacturing plant is gathered and analyzed. The small company has an assembly line of one specific model of sensor used in refrigerators. That is a new model of sensor with no historic data. According to the specification of the sensor, it has to be activated when the temperature is 80.4 degree Celsius (° C.). An analyst collected a sample of 20 units and the manager wants to know what is the probability of taking a sensor that will be activated without the specification range; it means P(X<80.4). The analyst has no idea of the shape of the distribution and no statistical knowledge to go deeper into this analysis.

The machine is able to reject automatically the sensors activated without the specification. It is important to estimate the yield of this model because it defines the expected level of rework the operation will have to do, affecting the cost and the planning of the operation. The data is in Table 5.

TABLE 5
Sample

| | | | |
|---|---|---|---|
| 82.00 | 96.48 | 84.51 | 119.75 |
| 112.69 | 95.12 | 115.74 | 107.86 |
| 101.35 | 82.05 | 128.18 | 103.89 |
| 96.26 | 84.15 | 89.32 | 105.60 |
| 105.83 | 80.94 | 138.56 | 101.02 |

Considering all samples had values greater than the specified value, a very basic analysis indicates that P(X<80.4)=0/20=0%. Table 6 gives the results using the proposed method and the benchmark (here Johnson Systems of distributions). During 1 month the analyst counted the number of rejected and approved sensors in the machine. After this time, 1534 units were produced, 339 rejected, so the actual yield was 22.1%.

TABLE 6
Calculation

| Method | Calculated | Error |
|---|---|---|
| Direct/Empirical | 0% | 22.10% |
| This invention | 18.7% | 3.40% |
| Benchmark/Johnson | 16.3% | 5.80% |

Table 6 shows the probability calculated and the errors based on the actual rejection. Naturally, the yield during the month depends on others variables such as raw-material, equipment maintenance, setup of the machine by the user and others, but it is a reference to analyze how accurate was the probability calculation. Another point is that even for such small sample size (only 20), the tool returned a very plausible answer.

3.2.9) Comparison with Other Tools

Here we focus on differentiating our invention from others. Basically, we want to show features of the One Click Universal Probability Calculator that makes it unique besides our proposed method:
No need of statistical knowledge from the user.
One-click based: minimum actions required.
Confidence level: output returning not only the probability value but also an estimate of the level of uncertain of the result, assisting the user in the decision-making process.

From our search we list similar/related products in Table 7 (ID 1 to ID 5) and our invention (ID 6):

TABLE 7
similar products/inventions

| ID | Name | Website |
|---|---|---|
| 1 | Mathportal | https://www.mathportal.ore/calculators/statistics-calculator/normal-distribution-calculator.php |
| 2 | Ncalculators | https://ncalculators.com/statistics/ |
| 3 | Statisticshowto | http://www.statisticshowto.com/calculators/ |
| 4 | Microsoft Excel | https://products.office.com/en-us/excel |
| 5 | Minitab | www.minitab.com |
| 6 | This invention | https://dunamath.com/homeUPC.aspx |

In order to better show differences among the tools, we refer to the following problem: assume we measured the lifetime of 40 hard drive discs (data sample). What is the probability of having a disc lasting longer than 1900 hours?

TABLE 8
data sample

| | | | | | | | |
|---|---|---|---|---|---|---|---|
| 1988.77 | 2026.69 | 2053.48 | 2140.11 | 2132.87 | 2062.56 | 1970.53 | 2164.22 |
| 2074.94 | 2018.67 | 1982.92 | 1924.92 | 2154.11 | 1788.89 | 2046.63 | 2019.41 |
| 1973.65 | 1921.29 | 1968.29 | 1753.65 | 1972.47 | 2028.2 | 2000.97 | 1960.72 |
| 1941.77 | 1937.22 | 1943.67 | 1957.47 | 1909.35 | 2018.27 | 2102.17 | 1695.47 |
| 1895.03 | 1942.83 | 2063.94 | 1678.59 | 1948.96 | 2050.25 | 1899.61 | 2058.53 |

Despite the fact that tools ID1, ID2 and ID3 are probability calculators, they are not able to solve the proposed problem, at least not completely. ID1 computes a probability where it is assumed the user already knows the distribution is normal. Note that this analysis would be part of the problem solving. Our invention does not require from the user knowing the type of distributions of the data. ID2 provides a “Probability Calculator” that computes the probability of a selected event based on probability of other events, which is not our case. They also have a “Gamma Function Calculator” that assumes the user already knows the data follows a Gamma distribution. They have equivalent calculators for other types of distribution. ID3 provides the “Binomial Distribution Calculator” and the “T distribution calculator”, also assuming the user knows the distribution type and the distribution parameters.

It is possible to give some answer to the proposed problem using tools ID4 and ID5 and we demonstrate how to answer the problem using such tools. Naturally, different people may use a different procedure while performing probability calculations with these tools, but we are going to use common procedures utilized by many professionals on the field.

### 3.2.9.1) Solution Using the Invention “Universal Provability Calculator (UPC)”

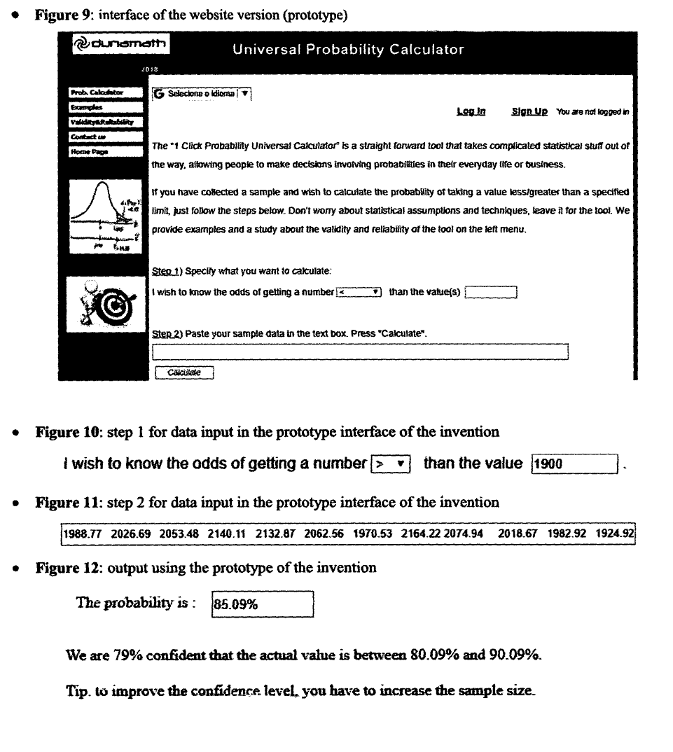

Here we demonstrate how to solve the problem using the website prototype version of our invention, FIG. 9.
Step 1: Just select the math symbol on the dropdown list and type the whished value, as showed in FIG. 10.
Step 2: Copy the data from the table and paste it in the text box (FIG. 11).

Note there are more values on the right of the field not showed in FIG. 11.

After clicking on “Calculate”, the output is displayed in FIG. 12.

Note that it is returned to the user not only the calculated probability value, but also a complementary information about the confidence of the result and a tip to improve it.

### 3.2.9.2) Solution Using ID4

Excel menu: Data->Data Analysis->Descriptive Statistics, select data sample from Table 8, then we have results in Table 9.

TABLE 9
Descriptive Statistics

| | |
|---|---|
| Mean | 1979.302 |
| Standard Error | 17.43848 |
| Median | 1978.285 |
| Mode | #N/A |
| Standard Deviation | 110.2906 |
| Sample Variance | 12164.02 |
| Kurtosis | 1.321178 |
| Skewness | −0.90893 |
| Range | 485.63 |
| Minimum | 1678.59 |
| Maximum | 2164.22 |
| Sum | 79172.09 |
| Count | 40 |

Kurtosis and Skewness are NOT close to zero, not too far too, but in this case, it is safer not assume the distribution is normal.

In Excel there is no straight method to deal with non-normal data. One alternative is to assume the data is not far from normal, and use Student Distribution, with

$$t = \frac{( x - \overline{x} )}{s} = \frac{( 1900 - 1979.30 )}{110.29} = - 0.719 ,$$

Excel command T.DIST(−0.719,39,1), resulting in 76.2%.

Another alternative is to use an Empirical Distribution Function (EDF), as showed in the next step.

A table with the Empirical Distribution is showed as follows:

TABLE 10
Empirical Distribution

| X(i) | q < X(i) | EDF < x | EDF > x |
|---|---|---|---|
| 1678.59 | 1 | 0.025 | 0.975 |
| 1695.47 | 2 | 0.05 | 0.95 |
| 1753.65 | 3 | 0.075 | 0.925 |
| 1788.89 | 4 | 0.1 | 0.9 |
| 1895.03 | 5 | 0.125 | 0.875 |
| 1899.61 | 6 | 0.15 | 0.85 |
| 1909.35 | 7 | 0.175 | 0.825 |
| 1921.29 | 8 | 0.2 | 0.8 |
| 1924.92 | 9 | 0.225 | 0.775 |
| 1937.22 | 10 | 0.25 | 0.75 |
| 1941.77 | 11 | 0.275 | 0.725 |
| 1942.83 | 12 | 0.3 | 0.7 |
| 1943.67 | 13 | 0.325 | 0.675 |
| 1948.96 | 14 | 0.35 | 0.65 |
| 1957.47 | 15 | 0.375 | 0.625 |
| 1960.72 | 16 | 0.4 | 0.6 |
| 1968.29 | 17 | 0.425 | 0.575 |
| 1970.53 | 18 | 0.45 | 0.55 |
| 1972.47 | 19 | 0.475 | 0.525 |
| 1973.65 | 20 | 0.5 | 0.5 |
| 1982.92 | 21 | 0.525 | 0.475 |
| 1988.77 | 22 | 0.55 | 0.45 |
| 2000.97 | 23 | 0.575 | 0.425 |
| 2018.27 | 24 | 0.6 | 0.4 |
| 2018.67 | 25 | 0.625 | 0.375 |
| 2019.41 | 26 | 0.65 | 0.35 |
| 2026.69 | 27 | 0.675 | 0.325 |
| 2028.2 | 28 | 0.7 | 0.3 |
| 2046.63 | 29 | 0.725 | 0.275 |
| 2050.25 | 30 | 0.75 | 0.25 |
| 2053.48 | 31 | 0.775 | 0.225 |
| 2058.53 | 32 | 0.8 | 0.2 |
| 2062.56 | 33 | 0.825 | 0.175 |
| 2063.94 | 34 | 0.85 | 0.15 |
| 2074.94 | 35 | 0.875 | 0.125 |
| 2102.17 | 36 | 0.9 | 0.1 |
| 2132.87 | 37 | 0.925 | 0.075 |
| 2140.11 | 38 | 0.95 | 0.05 |
| 2154.11 | 39 | 0.975 | 0.025 |
| 2164.22 | 40 | 1 | 0 |

In the Empirical Distribution table, in the first column we have the data sorted in ascending order. In the second column we have for each value the amount of values smaller or equal to the current value (which coincides with the row number). In the third column we have the value of the second column divided by the sample size resulting in a cumulative frequency. Finally, in the fourth column we have the complement of the third column

We want to calculate the probability of having a value greater than 1900. In the table, the value 1900 is between lines 6 and 7 (1899.61 and 1909.35). By doing so it is possible to say that the probability is around 82.5% and 85%. Note that there is no guarantee the true value is within this interval. But for a non-normal data, this is a simple method to give a notion of the probability.

### 3.2.9.3) Solution Using ID5

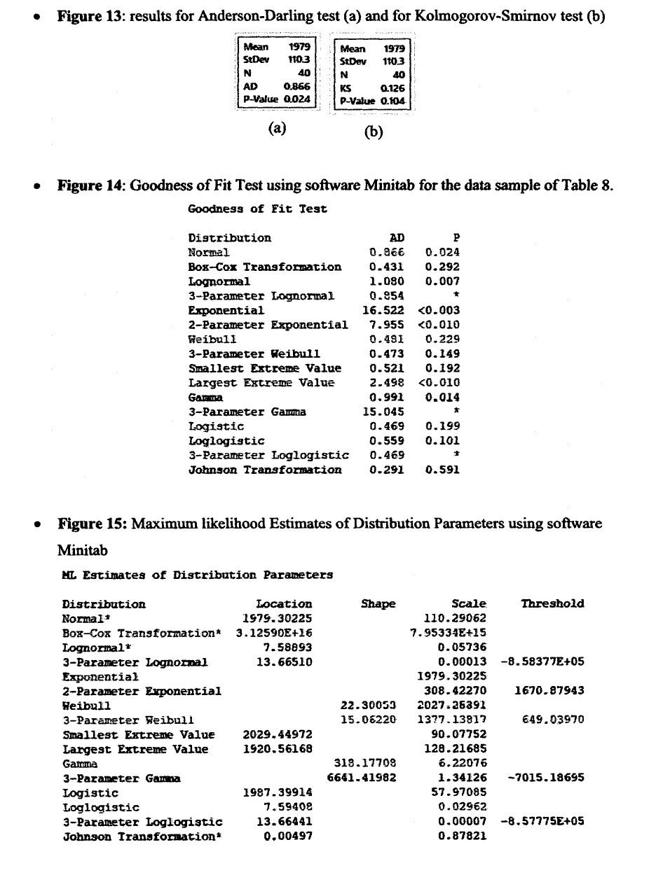

Initially we perform a test of goodness for a normal distribution. On Minitab: Stat, Basic Statistics, Normality Test, selecting tests Anderson-Darling (AD) and Kolmogorov-Smirnov (KS) which results are showed in FIG. 13.

For Anderson-Darling the null hypothesis of normality is rejected (p-value<0.05). Therefore, it is not plausible to assume the distribution is normal. Because the distribution is not normal, we need to estimate the type of the distribution. Minitab menu: Stat, Quality Tools, Individual Distribution Identification. By doing so, we get the table “Goodness of Fit Test” (FIG. 14), with an Anderson Darling test applied to different types of distribution. In general, all distributions with P smaller than 0.05 are immediately discarded. From the remaining ones, we get the one with greatest P value.

In our case, the first is “Johnson Transformation”, then “Box-Cox Transformation”, and after that, “Weibull”. Because the first two are transformations and not native distributions, and also, because there is no straight method to use them in Minitab, we pick the “Weibull” distribution.

Along with the table of FIG. 14, we also have the following table “ML Estimates of Distribution Parameters” (FIG. 15) with the parameter of each distribution. In our case, for the “3-Parameter Weibull”, there are 2 parameters: 22.30053 (shape) and 2027 (scale).

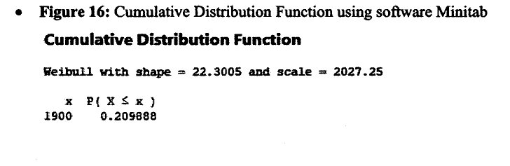

In the next step, on Minitab menu: Calc, Probability Distributions, Weibull. Select “cumulative probability”, type the 2 values of the parameters, in the field “input constant”, type the value 1900. By doing so, we have the answer in FIG. 16.

We want the probability of having values greater than 1900, so we have 1−0.2098=0.7902=79.02%. Finally an answer!

### 3.2.9.4) Discussion of the Results

First, we mention the source of the data: we generated 20000 values using the software Matlab, function: wblrnd(2042.6, 25.8773,20000,1) generating a population with Weibull distribution, mean 2000.3 and standard deviation 97.192. From that, we collected our 40 samples by chance. Because we generated the population we know the correct answer. A summary of the results is showed in Table 11.

TABLE 11
Summary of the results

| | ID4 - Excel | ID4 - Excel | | |
|---|---|---|---|---|
| ID6 - This | (using Student | (empirical | | Correct |
| invention | Distribution) | distribution) | ID 5 - Minitab | answer |
| 85.09% | 76.2% | [82.5%-85%] | 79.02% | 85.82% |

We already mentioned that ID1, ID2 and ID3 cannot solve the problem. Regarding the others tools, we see that both in Excel (ID4) and Minitab (ID6) the assumption of normality was rejected. Because Excel does not provide a straight forward method for non-normal distribution, we proposed the utilization of the Empirical Distribution Function just to have an idea of the probability, obtaining a value around 82.5% and 85%, which compared with the correct answer is a plausible value.

Using ID5, after a hard work identifying a suitable distribution type, its parameters, and performing the calculation, we've got a result of 79.02%.

For ID6 (this invention), the probability is 85.09%, with 79% confidence that the true value is between 80.09% and 90.09%. The error is smaller than Excel and Minitab, and the true value is within the estimated interval.

By this example, we see how complicated these analyses can become. It is complicated to calculate the probability, and after that, you still do not know the uncertainty of the result. The One click Universal Probability Calculator makes this calculation much easier, and also gives an estimate for the uncertainty involved. For example, we see that using ID5, the calculated probability is 79.02%. It is likely that the decision maker would believe in this result (79.02%) and make his decision. The tool ID4 (also tool ID5) does to make the user aware of how far the result might be from the true probability value.

Another point is that the user does not need to be worried with many statistical assumptions and trick details, it is everything treated by our algorithm (using the proposed method from Section 3.2.1 to Section 3.2.5) in the background.

### 4) CLAIMS

Once the product is in the market, we'd like to protect our unique interface based on one click calculation and also protect the method used to perform such calculations.

What is claimed is:

1. A product that puts together the following features:
1.1 Calculate probabilities for continuous and discrete data.
1.2 Return an estimation of the quality/accuracy of the answer (confidence level).
1.3 Based on one-click procedure: requiring the user to perform only the following actions:
a. Provide the sample data by importing a file or pasting/typing the data.
b. Enter a value of the cut-off point x for which is desired to calculate the probability and the desired math symbol (<, ≤, >, ≥, =).
c. Click on a button (or equivalent trigger) as described in Section 3.1.
Note that step b might be optional. If the user does not specify them, the tool can just compute probabilities for different values of x and return all probabilities to the user.
1.4 Calculate probabilities without requiring statistical knowledge from the user. It means a tool requiring from the user none of the following actions:
a) Normality test.
b) Test of goodness to identify which distribution function better fits the data set.
c) Use of transformation methods such as Johnson's family of distribution.
d) Knowledge of the type of the probability function (gamma, log-normal, exponential and others).
e) Knowledge of the nature of the variable: continuous or discrete.
f) Frequency table.
g) Utilization of an assistant in the interface of the tool where the user provides answers to a set of questions to guide him in the utilization of the correct statistical method.

2. A product as recited in claim 1 that can be presented to the user in the following ways:
a. An executable file (.exe) without interface with the user (no windows) where the input is a text file (or equivalent) and the output is another text file (or equivalent) with the results of the calculation. Similarly, it can be compiled as a. dll file as an option for integration with other software.
b. A software, opened through an executable file (.exe) or a website with an interface that allows the user to perform the actions listed in claim 1.3 and also displays the results. Optionally, the product can display supplementary information such as a graph of the histogram and cumulative probability function.
c. Embedded into an electronic pocket calculator/scientific calculator/similar device, where the user can perform actions from claim 1.3a and 1.3b by typing the data using the calculator pad and performing action 1.3c by pressing a key.

3. A product benefiting from the method described in the section 3.2, applied for continuous and discrete distributions, based on the following milestones:
a. Method described in Section 3.2.1.1 allowing the split of a value between two adjacent intervals of the frequency table.
b. Utilization of piecewise functions formed by two polynomial equations to estimate the cumulative function directly from the frequency table (Section 3.2.1.2).
c. Utilization of a method that performs the calculations for different number of bins, and based on a quality score, combines the results of the best ones to have a final result (Algorithms 1 and 2).
